(19) United States
(12) Patent Application Publication
(10) Pub. No.: US 2023/0334781 A1
(43) Pub. Date: Oct. 19, 2023

(54) SIMULATION SYSTEM BASED ON VIRTUAL ENVIRONMENT

(71) Applicant: Invant Inc., Suwon-si (KR)

(72) Inventors: Jin Hyuk YANG, Seongnam-si (KR); Chang Hwan SHON, Yongin-si (KR); Ho Sik KIM, Gwangju-si (KR); Hyung Seok KIM, Suwon-si (KR)

(21) Appl. No.: 18/134,560

(22) Filed: Apr. 13, 2023

(30) Foreign Application Priority Data
Apr. 19, 2022 (KR) 10-2022-0048407
May 11, 2022 (KR) 10-2022-0058031

(51) Int. Cl. G06T 19/00; G06T 19/20

(52) U.S. Cl. CPC G06T 19/003; G06T 19/20; G06T 2210/21; G06T 2219/2016

(57) ABSTRACT

A simulation system is provided. The simulation system includes a storage including a virtual space and virtual environment data based on the virtual space, a real-time simulation module configured to map terrain data to the virtual space and simulate movement of a virtual object, a background generating module configured to generate a background of the virtual environment based on the virtual environment data, and a visualization module configured to superimpose the movement of the virtual object on the background of the virtual environment and display a user screen using a display module.

### CROSS-REFERENCE TO RELATED APPLICATION(S)

This application is based on and claims priority under 35 U.S.C. § 119(a) to a Korean patent application number 10-2022-0048407, filed on Apr. 19, 2022, in the Korean Intellectual Property Office, and a Korean patent application number 10-2022-0058031, filed on May 11, 2022, in the Korean Intellectual Property Office, the disclosure of which is incorporated by reference herein its entirety.

### BACKGROUND

### 1. Field

This disclosure relates to a simulation system based on a virtual environment.

### 2. Description of Related Art

A conventional simulation system provides the virtual environment based on photos of an actual golf course or 3D graphics expressing the actual golf course. For example, photos of the actual golf course may include photos taken using a drone or photos taken from the ground. In this case, the user's terminal may perform simulation by mapping simulation information to the virtual environment and rendering the virtual environment in real time.

That is, the user's terminal should have high graphic processing capabilities, allowing it to render images or photos in real time. As the quality of the virtual environment improves, higher graphics processing performance is required.

Recently, as mobile devices such as smartphones have become widely available, there is a need for a simulation system capable of providing realistic graphics even on low-end devices like smart phones.

The above information is presented as background information only to assist with an understanding of the disclosure. No determination has been made, and no assertion is made, as to whether any of the above might be applicable as prior art with regard to the disclosure.

### SUMMARY

It is known that simulation users experience greater interest and realism when performing actions that are difficult to implement in reality through simulations, rather than in a virtual environment composed of actual photographs. For example, in a virtual environment created from actual photographs, if the images are not prepared in advance, the user's actions or field of view may be limited, which diminishes their desire to participate in the simulation.

Aspects of the disclosure are to address at least the above-mentioned problems and/or disadvantages and to provide at least the advantages described below. Accordingly, an aspect of the disclosure is to provide a simulation system a simulation system capable of offering a virtual environment similar to an actual environment, along with a high degree of freedom for users.

In accordance with an aspect of the disclosure, the simulation system based on the virtual environment is provided. The simulation system comprises a storage including a virtual space and virtual environment data based on the virtual space; a real-time simulation module configured to map terrain information data to the virtual space and simulate motion of a virtual object; a background generating module configured to generate a background of the virtual environment based on the virtual environment data; and a visualization module configured to superimpose the movement of the virtual object on the background of the virtual environment and display a user screen using a display module.

The simulation system of the disclosure provides a virtual environment based on an image or video rendered through a virtual camera defined in a virtual space. Through this virtual environment, users can have a high degree of freedom and feel realism. In addition, the simulation system of the disclosure provides a high-quality virtual environment even on user terminals with relatively low graphics processing performance by utilizing pre-prepared, high-quality images or videos.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of the simulation system 100 according to one embodiment of the disclosure;

FIG. 2 is a block diagram of the simulation system 100 according to another embodiment of the disclosure;

FIG. 3 is a block diagram of the method for obtaining the virtual environment data of the simulation system 300 according to one embodiment of the disclosure;

FIGS. 4 and 5 are views illustrating examples of the virtual space with the virtual grid of the simulation system 100 according to one embodiment of the disclosure;

FIGS. 6A, 6B, and 6C are examples of the virtual environment data of the simulation system 100 according to one embodiment of the disclosure;

FIGS. 7A and 7B are examples of generating the background of the virtual environment data;

FIG. 8 is a view illustrating the user's field of view of the simulation system based on the virtual environment 100 according to one embodiment of the disclosure;

FIG. 9 is a flow chart illustrating the simulation method of the simulation system 900 according to an embodiment of the disclosure;

FIG. 10 is a view illustrating the depth data of the simulation system based on the virtual environment 100 according to one embodiment of the disclosure;

FIG. 11A is a view illustrating the virtual environment data in a state in which the virtual object is in the tee box;

FIG. 11B is a view illustrating the user screen in the tee box;

FIG. 12A is a view illustrating the virtual environment data in a state in which the virtual object is flying;

FIG. 12B is a view illustrating the user screen in a state in which the virtual object is flying;

FIG. 13A is a view illustrating the virtual environment data in a state in which the virtual object is falling; and

FIG. 13B is a view illustrating the user screen in a state in which the virtual object is falling.

Throughout the drawings, like reference numerals will be understood to refer to like parts, components, and structures.

### DETAILED DESCRIPTION

The following description with reference to the accompanying drawings is provided to assist in comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

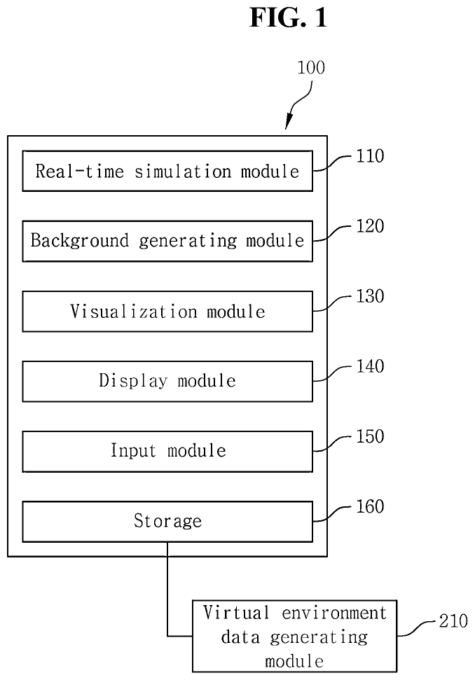

FIG. 1 is a block diagram of the simulation system 100 according to one embodiment of the disclosure.

Referring to FIG. 1, The simulation system 100 based on virtual environment may comprise an input module 150, a real-time simulation module 110, a background generating module 120, a visualization module 130, and a display module 140.

In one embodiment, the input module 150 may be configured to receive user input. The input module 150 may include various commonly used input modules such as a keyboard, a mouse, a touch panel included in a display, or a joystick.

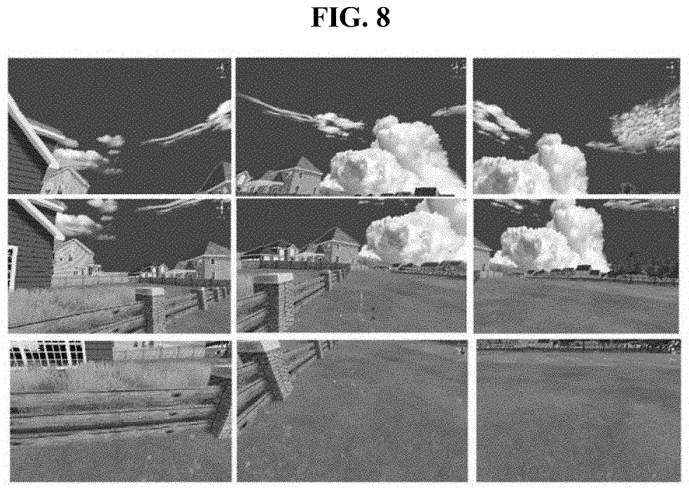

The user input may include a command affecting the position or movement of a virtual object (e.g., golf ball), or a command to change the field of view of the user screen displayed through the display module 140 (e.g., FIG. 8).

In one embodiment, the display module 140 may be configured to display the visual information provided by the visualization module 130.

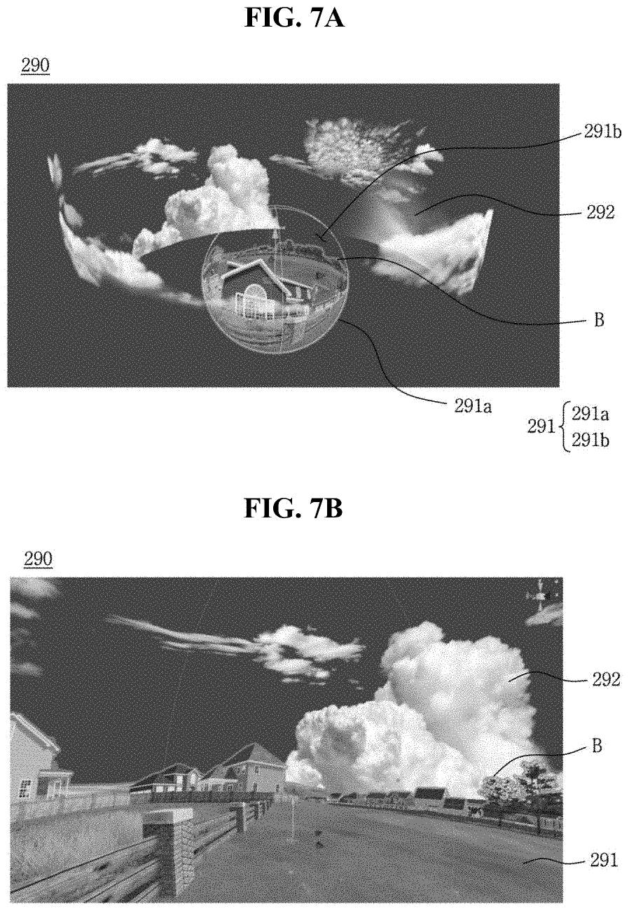

In one embodiment, storage 160 may store data related to the virtual environment, such as images (e.g., a first image 291), videos (e.g., a first video 292) or digital media. For example, digital media may include images or videos constituting the background (e.g., the background 290 of FIGS. 7A and 7B).

In one embodiment, digital media may be generated through the virtual environment data generating module 210. The virtual environment data generating module 210 may be a component of the simulation system 100, or a separately provided system or device.

In one embodiment, the digital media stored in the storage 160 may be generated by modeling a virtual space to simulate a real golf course.

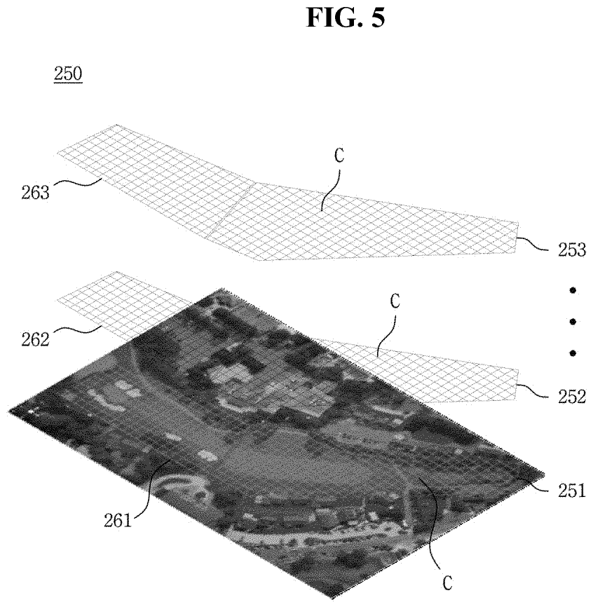

The virtual environment data generating module 210 is configured to generate digital media by modeling a virtual space that simulates a real golf course and rendering the images or the videos taken in the modeled virtual space. The images or the videos may be captured through virtual cameras defined in the virtual space. The virtual space may be divided into a plurality of spaces or areas (e.g., the first grid 261, the second grid 262, and the third grid 263 of FIG. 5). The virtual camera can be defined to correspond to the divided spaces or areas.

In one embodiment, the storage 160 may be connected to the background generating module 120 and the real-time simulation module 110 to transmit/receive data.

In one embodiment, the storage 160 includes a data structure having the virtual camera information as an index and the images or videos taken from the virtual camera as data. The images or videos included in the data structure as data may be stored in a rendered state. Using the index of the data structure, the images or videos related to a specific location in the virtual space can be accessed.

In one embodiment, the background generating module 120 may be configured to generate a background 290 of a virtual environment. The background 290 of the virtual environment may include the digital media stored in the storage 160 (e.g., images or videos).

In one embodiment, the background generating module 120 may select appropriate images or videos from among images or videos stored in the storage 160, and create the background for the virtual environment. For example, the background generating module 120 may receive appropriate virtual camera information determined by the real-time simulation module 110, and access the digital media (e.g., images or videos) stored in the storage 160 through the virtual camera information. Then, the background generating module 120 may form the background 290 based on the accessed images or videos.

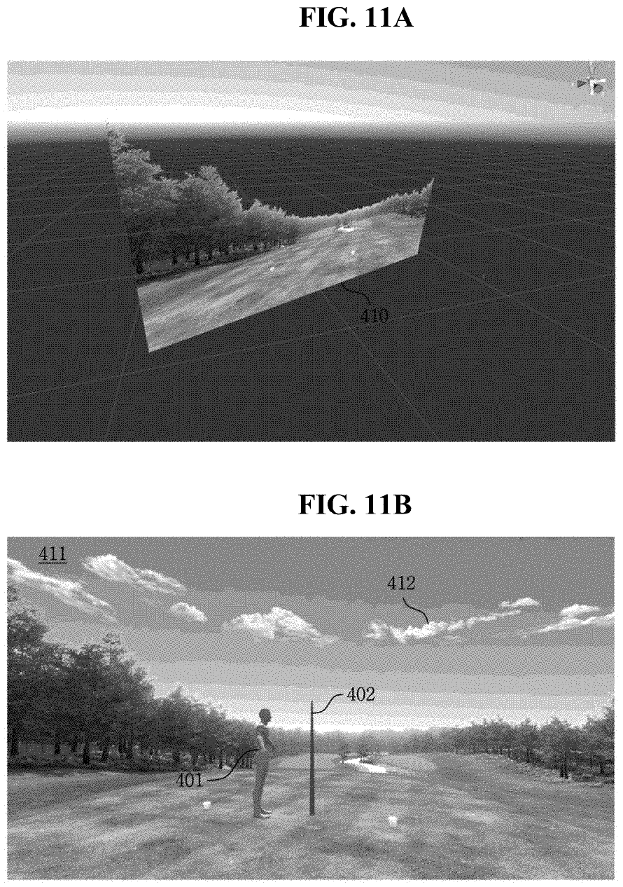

In one embodiment, the background generating module 120 may be connected to the real-time simulation module 110 to transmit data. For example, when a hit (e.g., a tee shot in FIGS. 11A and 11B) is made to a stationary virtual object (e.g., a golf ball), the real-time simulation module 110 may calculate the trajectory of the virtual object and determine the virtual cameras of appropriate position and transmit the result to the background generating module 120. Then, the background generating module 120 may access the virtual environment data (e.g., rendered images or videos from the virtual camera) based on the appropriate virtual camera information.

In another example, the real-time simulation module 110 may be configured to select the appropriate virtual camera based on the calculated information about the motion of the virtual object, access rendered images or videos from the appropriate virtual camera stored in the storage 160, and then transfer them to the background generating module 120. In this case, the background generating module 120 may form the background 290 of the virtual environment using the images or videos received from the real-time simulation module 110 without accessing the storage 160.

In one embodiment, the background generating module 120 may be configured to composite additional images or videos to the images or videos selected as appropriate. The additional images or videos may include objects that require motion among objects existing in the virtual environment. For example, it may be natural for clouds, streams, etc. included in the background 290 to move according to the passage of time.

The background generating module 120 is configured to process the first area 291b of the selected images or videos as transparent, and composite the additional video, which includes motion of the object, onto the first area 291b.

The second area 291a may be defined as an area other than the first area 291b in the background of the virtual environment. The second area 291a may include a fixed structure or a terrain of the virtual environment in which movement is unnatural.

In another example, some images or videos may be stored in the storage 160 with a partial area (e.g., the first area 291b) removed. That is, the rendered images for the second area 291a may be stored in the storage 160. In this case, the appropriate images or videos may be composited onto the removed area (e.g., the first area 291b) according to simulation conditions.

In one embodiment, various additional images or videos may be composited onto the first area 291b according to various conditions (e.g., weather, wind direction, wind speed, temperature, etc.) in the simulation. Through this, even if the user simulates in the same virtual environment (e.g., the same golf course), the first area 291b of the background 290 is displayed differently, so that the user can feel realism and liveliness.

In one embodiment, the real-time simulation module 110 may be configured to calculate the motion of the virtual object (e.g., golf ball) based on the user input, select the appropriate virtual camera based on the calculated information, and generate control information of the virtual camera.

In one embodiment, the real-time simulation module 110 may map 3D terrain data onto the virtual environment to simulate the motion of the virtual object. In this case, the 3D terrain data may be mapped onto the virtual environment in a transparent manner, making it invisible to the user.

In one embodiment, the 3D terrain data include information necessary for physical simulation of the virtual object, such as a slope, shape, and material of the ground for the physical simulation of the virtual object. The 3D terrain data may include data on structures (e.g., trees, buildings) capable of interacting (e.g., collision) with virtual objects.

The 3D terrain data may be defined in the same 3D coordinate system as the virtual space so as to be mappable to the virtual space. The 3D terrain data may be defined in a grid form. The 3D terrain data may be referred to as topography. An area covered by the 3D terrain data may be provided in a size smaller than or equal to the size of the ground included in the virtual space. For example, 3D topographical data may not be provided to areas where virtual objects cannot be located among the ground included in the virtual space (e.g., out of bound area or hazard area).

In various embodiments, the 3D terrain data may be entirely or partially mapped to virtual space. The 3D terrain data may be mapped to a virtual space before calculating a motion of a virtual object according to a user input. In this case, the 3D terrain data may be mapped to the entire area of the virtual space.

For another example, the 3D terrain data may be mapped to a virtual space after a motion of a virtual object, after the movement of the virtual object according to the user input is calculated. In this case, the 3D terrain data may be mapped only to an area including a predicted position (e.g., drop point) of the virtual object.

In one embodiment, the real-time simulation module 110 may calculate information including the trajectory, the highest point (e.g., peak point), and the drop point of the virtual object based on a user input received through the input module 150, the 3D terrain data, and conditions within the simulation (e.g., wind speed, wind direction, weather, etc.). Specifically, the flight trajectory and maximum height of the virtual object may be related to the speed and strength of hitting the virtual object, the hitting point of the virtual object, the launch angle. The predicted position of the virtual object may be related to 3D terrain data of the drop point.

In one embodiment, the real-time simulation module 110 may select the virtual camera at the appropriate location based on the calculated information. For example, the virtual camera in the appropriate location can be the closest virtual camera to the moving or stationary virtual object. However, the virtual camera selected by the real-time simulation module 110 is not limited to the virtual camera closest to the virtual object. For example, the real-time simulation module 110 may select a virtual camera capable of supporting various views (e.g., bird view, sky view, etc.) that provide a sense of reality to the user.

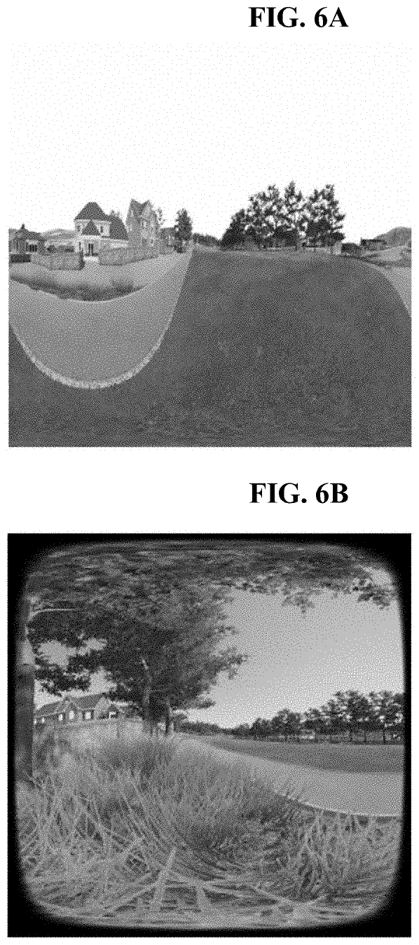

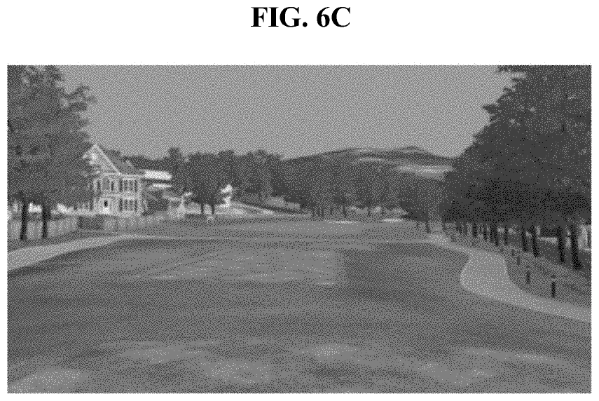

In one embodiment, the real-time simulation module 110 may be connected to the background generating module 120 in a data transmission manner, and transmit the selected virtual camera information to the background generating module 120. The background generating module 120 may generate the background of the virtual environment based on the selected virtual camera information, based on the rendered images or videos (e.g., FIGS. 6A, 6B, and 6C) from the selected virtual camera.

In another example, the real-time simulation module 110 may directly load the rendered images or videos from the selected virtual camera from the storage 160 and transfer them to the background generating module 120.

In one embodiment, the real-time simulation module 110 may control each selected virtual camera. For example, the real-time simulation module 110 may control the virtual camera so that the virtual object (e.g., a golf ball) or a virtual player (e.g., an avatar) is located in the central area of the visual field of the virtual camera. For example, the real-time simulation module 110 may control the virtual camera to track the moving virtual object. For example, the control of the virtual camera may include the direction of the virtual camera, a field of view (F.O.V) of the virtual camera, and a moving speed of the virtual camera (e.g., rotational speed).

For example, the moving speed of the virtual camera may be related to the moving speed and angle of the virtual object. For example, the direction of the virtual camera may be related to the direction, speed, angle, etc. of the virtual object entering or leaving the field of view of the virtual camera.

In one embodiment, the visualization module 130 may configure a user screen related to a virtual object or a player based on information received from each of the real-time simulation module 110 and the background generating module 120 and display the user screen through the display module 140. The user screen is an area included in the field of view of the virtual camera and may be defined as a partial area of the background. The virtual object or player may be displayed in the central area of the user screen.

In one embodiment, the visualization module 130 may load the background 290 of the virtual environment generated by the background generating module 120. For example, the loaded background 290 may not have directionality like the sphere-rendered background of FIG. 6A. Alternatively, the loaded background 290 may be a background in which the virtual camera does not direct the virtual object. Therefore, the visualization module 130 may control the virtual camera so that the virtual object or player is located in the center area of the screen based on the virtual camera control information (field of view, direction, etc.). For example, the visualization module 130 may match the generated background with properties of the virtual camera capturing the virtual object.

In one embodiment, the visualization module 130 may map user input and information calculated by the real-time simulation module 110 (e.g., the position, motion, and trajectory of a virtual object) to a screen. If the virtual object is moving, the visualization module 130 may display the virtual object according to the calculated information and/or display a screen for tracking the virtual object based on the camera control information.

For example, the real-time simulation module 110 is configured to set basic properties (e.g., direction, field of view, etc.) of the virtual camera according to simulation results. The visualization module 130 may be configured to receive additional user input and change the basic properties. For example, in the predicted drop position of the virtual object, the real-time simulation module 110 may set basic properties of the virtual camera and transmit them to the visualization module 130. For example, the user can have the field of view in left, right, up, and down directions by manipulating a mouse or a keyboard. In response to this, the visualization module 130 may provide a view desired by the user by rotating the virtual camera.

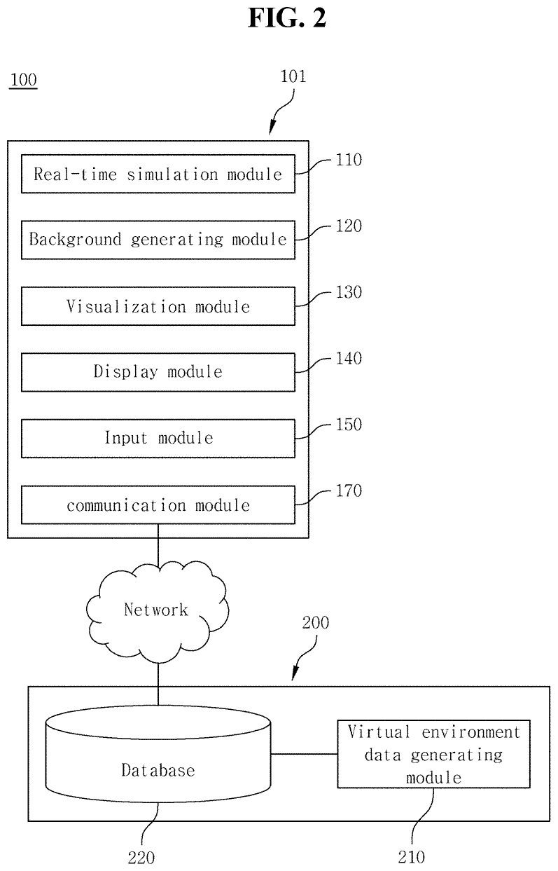

FIG. 2 is a block diagram of the simulation system 100 according to another embodiment of the disclosure.

Referring to FIG. 2, The simulation system 100 based on virtual environment 100 according to another embodiment may include a server 200 and a client 101 connected to the server 200 through a network.

Referring to FIG. 2, The server 200 may include a virtual environment data generating module 210 and a database 220. The client 101 may include an electronic device (e.g., PC, smart phone) including the input module 150, the real-time simulation module 110, the background generating module 120, the visualization module 130, and the display module 140. The input module 150, the real-time simulation module 110, the background generating module 120, the visualization module 130, and the display module 140 included in the client 101 are the same as those described in FIG. 1, Therefore, further description is not provided here.

In one embodiment, the client 101 and the server 200 are connected through a network, which may include a global network such as the Internet or a local network such as an intranet. For this purpose, the client 101 may include a communication module. The communication module 170 may support at least one of various wired and wireless communications (LAN, WIFI, 5G, LTE, etc.).

In one embodiment, the client 101 may be configured to access and/or load digital media stored in the database 220 of the server 200 (e.g., images or videos of FIGS. 6A, 6B, and 6C) through the communication module 170. For example, the background generating module 120 of the client 101 may access and/or download images or videos stored in the database 220 of the server 200.

In one embodiment, the virtual environment data generating module 210 may be configured to generate the virtual environment data related to the virtual space in which the simulation is performed and presented to the user. The virtual environment data may include images or videos rendered through multiple virtual cameras defined in the virtual space. The virtual environment data generating module 210 may store the images or videos in the database 220. In various embodiments, the database 220 shown in FIG. 2 may be referred to as the storage 160 shown in FIG. 1.

In summary, the virtual environment data may include digital media, such as images or videos, which are stored in either the storage 160 or the database 220. As described above, the digital media may include the result obtained by photographing at least a portion of the virtual space using the virtual camera.

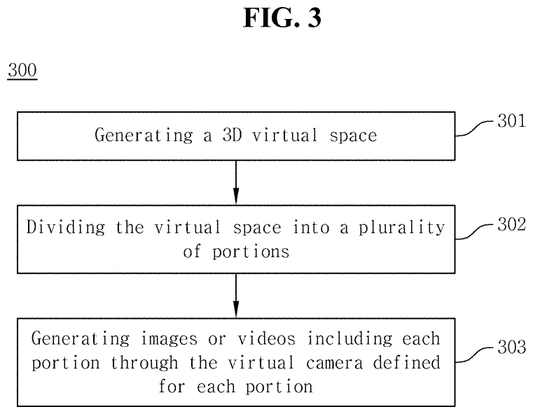

FIG. 3 is a block diagram of the method 300 for obtaining the virtual environment data of the simulation system according to one embodiment of the disclosure.

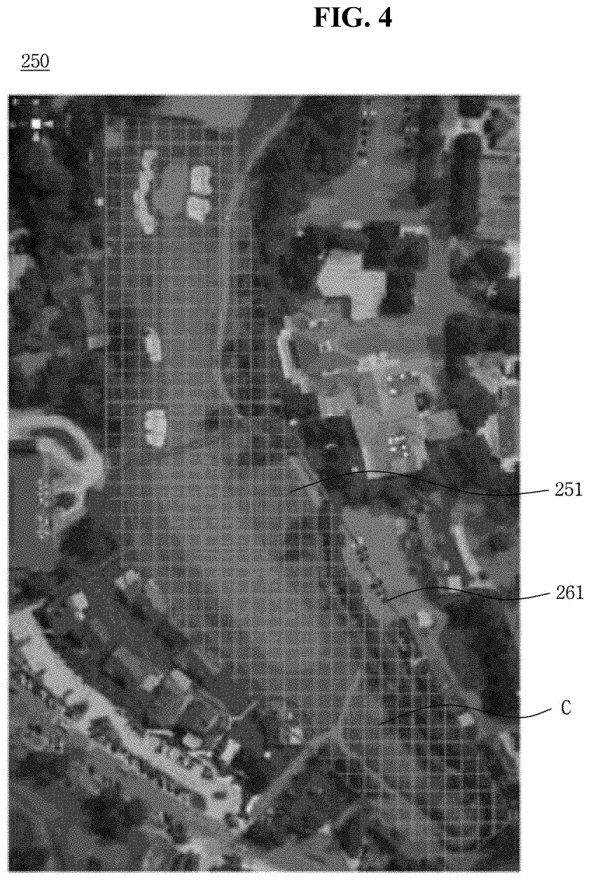

FIGS. 4 and 5 are views illustrating examples of the virtual space with the virtual grid of the simulation system 100 according to one embodiment of the disclosure.

Referring to FIG. 3, the method 300 for obtaining the virtual environment data may be performed by the virtual environment data generating module 210 shown in FIG. 2. The data obtained through this method 300 shown may be stored in the storage 160 shown in FIG. 1 or stored in the database 220 shown in FIG. 2.

Referring to FIG. 3, the method 300 for obtaining the virtual environment data comprises: Generating a 3D virtual space 301; Dividing the virtual space into a plurality of portions 302; and Generating images or videos including each portion using the virtual camera defined for each portion 303.

In one embodiment, in the step 301, the virtual space may be configured to include a space where various sports games are held and an area surrounding the space. For example, the virtual space may include a golf course, an athletics track, a soccer field, and a baseball field. Referring to FIGS. 4 and 5, the virtual space may also include a golf course and surrounding terrain and structures such as a house and trees.

In one embodiment, the virtual space may be defined as a fully rendered 3D modeled space that closely resembles a real-world environment. Alternatively, the virtual space may be defined as a partially rendered 3D modeled space where rendering is only performed on parts of the space that are within the field of view of a virtual camera.

In one embodiment, the step 302, may comprise dividing the virtual space into two dimensions (e.g., FIG. 4) or three dimensions (e.g., FIG. 5). For example, referring to FIG. 4, a grid 261 may be formed in a virtual space including a golf course. On the ground 251 of the golf course, virtual straight lines extending in different directions and a plurality of virtual intersection points C are defined. the virtual cameras are defined at each of the virtual intersection points C.

For another example, referring to FIG. 5, the virtual space may be divided into three dimensions. A plurality of layers 251, 252, and 253 are defined in the virtual space. Grids 261, 262, 263 and a plurality of virtual intersection points C are defined in each of the layers 251, 252, and 253. The virtual camera may be defined at each of the virtual intersection points C. For example, the first layer 251 may be defined the same as the ground of the virtual space. The third layer 253 may be defined at the top layer of the virtual space. The second layer 252 may be defined as a layer between the first layer 251 and the third layer 253. In various embodiments, the second layer 252 may include a plurality of layers. In other words, the number of layers is not limited to three as shown in the drawing and may be more than three.

In one embodiment, the virtual space may be divided into different sizes. For example, the virtual space may be divided into relatively large sizes at the periphery of the tee box. For example, the virtual space may be divided into relatively small sizes at the periphery of the fairway or the periphery of the hole cup (e.g., the green), because various fields of view and many virtual cameras are required. For example, referring to FIG. 5, the third layer 253 defined as the uppermost layer may be divided into relatively large sizes.

In one embodiment, the step 303, may comprise defining a virtual camera at a designated location in virtual space. In this case, the designated position in the virtual space may be the intersection point C of the lattices shown in FIGS. 4 and 5.

In one embodiment, each virtual camera may be configured to capture images or videos of the virtual space at the designated location. The captured images or videos may include panoramic views, with some virtual cameras having a 360-degree field of view in up, down, left, and right directions shape (e.g., FIG. 6A) while others may have a 180-degree field of view (e.g., FIG. 6B) or a flat view (e.g., FIG. 6C). In some embodiments, the captured images or videos may be rendered as a plane, a sphere, or a partially sphere.

In certain embodiments, step 303 may further comprise rendering the images or videos captured through the virtual cameras, which may be performed by the virtual environment data generating module 210 shown in FIG. 2.

FIGS. 6A, 6B, and 6C are examples of the virtual environment data of the simulation system 100 according to one embodiment of the disclosure.

In particular, FIG. 6A is a sphere-rendered image, FIG. 6B is a half sphere-rendered image, and FIG. 6C is a plane-rendered image. These images were taken using the virtual cameras located at the different points such as the virtual intersection points C.

In one embodiment, the sphere-rendered image may be produced based on a panoramic image captured using a first virtual camera designed for sphere-panorama shooting. For example, the first virtual camera may have a 360-degree field of view in all directions. The sphere-rendered image can be mapped to an imaginary sphere. In this case, the virtual object such as the golf ball or the virtual player may be located near the center of the virtual sphere. As a result, the user can have a 360-degree view around the player or the golf ball, providing the user with high degrees of freedom.

In one embodiment, the half-sphere rendered image may be produced based on a panoramic image captured using a second virtual camera designed for half-sphere panoramic shooting. For example, the second virtual camera may have a 180-degree field of view. The half-sphere rendered image may be partially mapped to an imaginary sphere. In this case, the virtual object such as the golf ball or the virtual player may be located near the center of the virtual sphere. As a result, the user would have a 180-degree field of view around the player or the golf ball, providing the user with high degrees of freedom.

The virtual environment data referred to in this disclosure may include partial sphere panoramic images of various views according to characteristics of each point in the virtual space. The sphere image and the half sphere image shown in the figures should be understood as examples of the virtual environment data.

In one embodiment, the plane-rendered image may be rendered based on a plane image captured through a third virtual camera defined to enable plane shooting. For example, the third virtual camera may have a field of view of less than 180 degrees in up, down, left, and right directions.

In one embodiment, the field of view of the virtual camera may vary according to a feature of a point in the virtual space in which the virtual camera is defined.

For example, since a tee shot is performed from the tee box toward the front, it does not matter if the user is provided with a limited field of view. In this case, the virtual camera near the tee box may be defined as the third virtual camera having a plane field of view facing forward.

In another example, since the virtual camera defined in the third layer 253, which is positioned higher than the highest point of the golf ball, may not require a top view. Therefore, the virtual camera located in the third layer 253 may be defined as the second virtual camera with a half-sphere field of view, capturing a direction towards the ground.

As another example, the virtual camera defined on the fairway of the first layer 251, which represents the ground of the virtual space, may be defined as the first virtual camera with a sphere field of view. This allows the user to have a wide field of view, including front, rear, sideward, and upward views, and enables a simulation with a high degree of freedom.

FIGS. 7A and 7B are examples of generating the background of the virtual environment data. FIG. 8 is a view illustrating the user's field of view of the simulation system 100 based on the virtual environment according to one embodiment of the disclosure.

Referring to FIGS. 7A and 7B, the background generating module 120 may generate the background 290 of the virtual environment by using the virtual environment data (e.g., images or videos, the first image 291) acquired through the virtual camera. Alternatively, the background generating module 120 may generate the background 290 of the virtual environment by compositing additional images or videos (e.g., the second image 292) with the virtual environment data.

In one embodiment, the virtual environment data stored in the storage 160 or the database 220 further includes the first image 291 acquired through the virtual camera and the second image 292 provided to be composited with the first image 291.

In one embodiment, the background generating module 120 may render the first area 291b of the first image 291 transparent and overlay the second image 292 onto the transparent first area 291b. As a result, the background 290 of the virtual environment may include both the second area 291a of the first image 291 and the second image 292. The second image 292 may correspond to the field of view of the first image 291. For example, the first image 291 could be a still image (e.g., FIGS. 6A and 6B) rendered in a partially spherical shape, while the composited second image 292 could be a video. This arrangement may give the user a sensation similar to playing a game on an actual golf course.

Referring to FIG. 8, the user may be given a high degree of freedom in selecting various views. The user's field of view may correspond to a field of view of the virtual camera. Through the input module, the user can adjust the field of view in up, down, left, right, front, and back directions around the golf ball.

Since the conventional golf simulation is based on photos taken of actual golf courses, a user screen cannot be provided for locations or directions where photos have not been taken. That is, in the conventional golf simulation, the user's field of view is limited, but the simulation system 100 disclosed in this disclosure provides a user with a high degree of freedom, so that the user can play a game with a high degree of freedom similar to a real golf game.

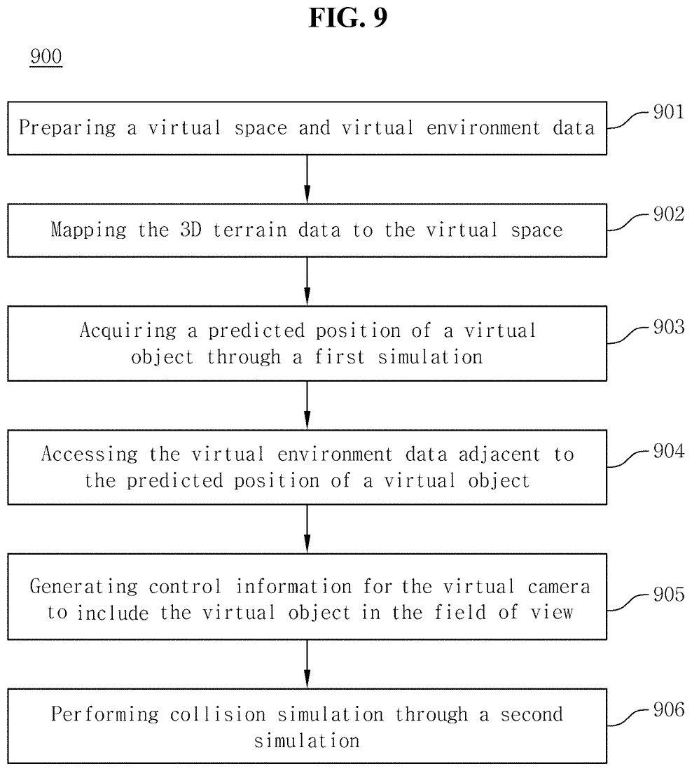

FIG. 9 is a flow chart illustrating the simulation method of the simulation system 900 according to an embodiment of the disclosure.

Referring to FIG. 9, The simulation method 900 may comprise: Preparing a virtual space and virtual environment data 901; Mapping the 3D terrain data to the virtual space 902; Acquiring a predicted position of a virtual object through a first simulation 903; Accessing the virtual environment data adjacent to the predicted position of a virtual object 904; Generating control information for the virtual camera to include the virtual object in the field of view 905; and Performing collision simulation through a second simulation 906.

In one embodiment, in the step 901, the virtual space and virtual environment data may be prepared by performing method 300 shown in FIG. 3 by the virtual environment data generating module 210 of FIG. 2.

In one embodiment, in the step 902, the 3D terrain data may be mapped transparently, such that it is not visible to the user. The 3D terrain data may include information necessary for physical simulation of the virtual object, such as the slope, shape, and material of the ground, for the physical simulation of the virtual object. For example, the 3D terrain data may include data on a structure (e.g., a tree, a building, etc.) capable of interacting (e.g., collision) with the virtual object in addition to the topography of the virtual environment. For example, the 3D terrain data may be defined in the same 3D coordinate system as the virtual environment so as to be mappable to the virtual environment. The 3D terrain data may be defined in a grid form. The 3D terrain data may be referred to as topography.

Referring to the FIG. 9, although the step 902 may be performed before the step 903, it is not necessarily limited thereto. For example, the step 902 may be performed after the step 903. In this case, the 3D terrain data may not be mapped to the entire virtual space, but may be mapped only to the surrounding area including the predicted drop position (e.g., a drop point) of the virtual object.

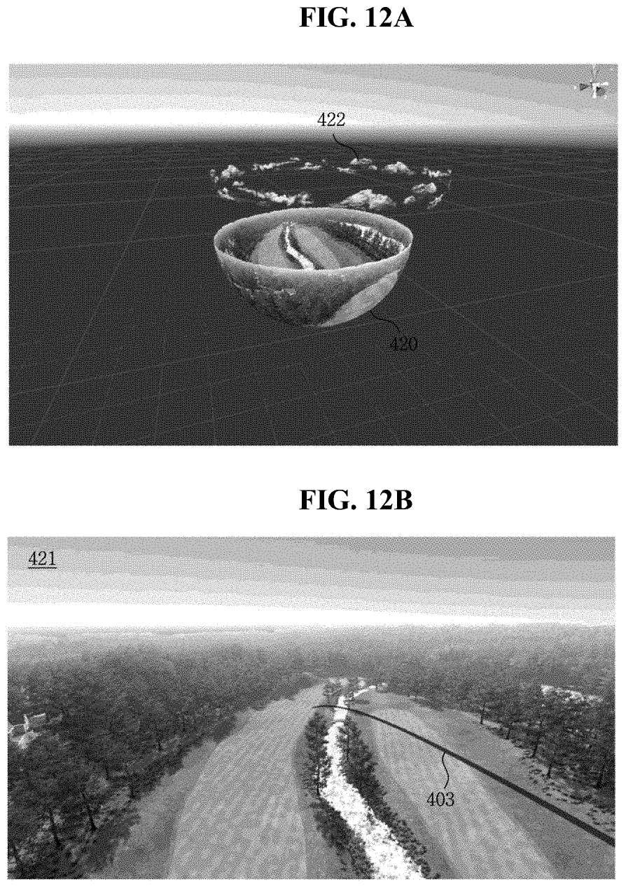

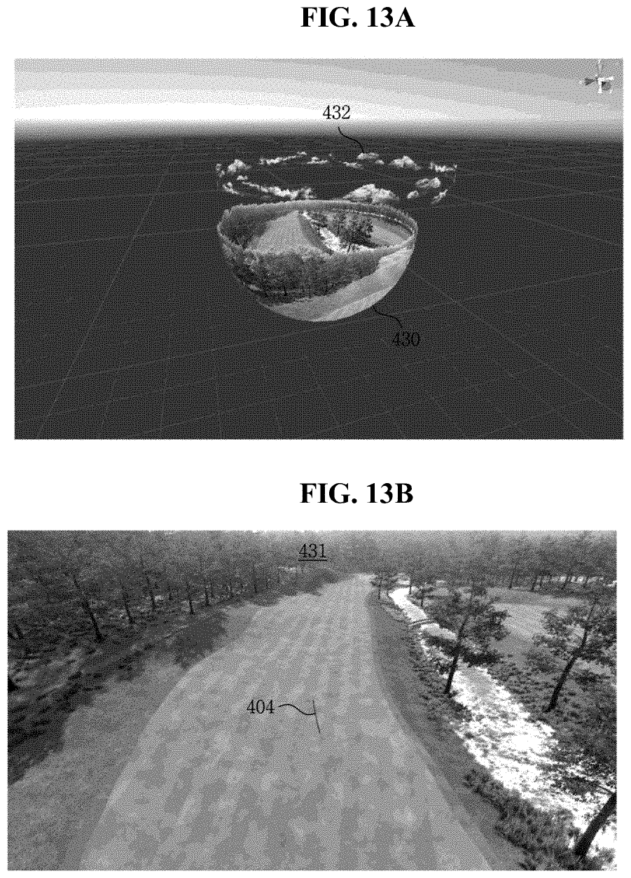

In the step 903, the real-time simulation module 110 may calculate a predicted position of the virtual object based on the user input received through the input module and the conditions in the simulation (e.g., wind speed, wind direction, weather, etc.). In various embodiments, the predicted position obtained through the first simulation may include the position where the virtual object is expected to stop, such as the drop position shown in FIGS. 13A and 13B, as well as the highest point of the virtual object in flight, as shown in FIGS. 12A and 12B.

In the step 904, the real-time simulation module 110 may select the virtual camera nearest to the predicted position and transmit the corresponding camera information to the background generating module 120.

In various embodiments, the real-time simulation module 110 may select the virtual camera adjacent to the highest point of the virtual object and transmit corresponding camera information to the background generating module 120. The background generating module 120 may use the information provided by the real-time simulation module 110 to configure the background of the virtual environment.

In the step 905, The real-time simulation module 110 may directly control the virtual camera or generate control information to position the virtual object, such as the golf ball, or the virtual player, such as the avatar, at the center of the user screen. For example, the virtual camera may be configured to track a moving virtual object. The real-time simulation module 110 may transfer the generated control information to the visualization module 130.

In the step 906, the virtual object may be simulated for collision based on the 3D terrain data of the predicted drop point (e.g., FIGS. 13A and 13B). The real-time simulation module 110 may transfer information that was previously acquired or generated, such as a drop point, a peak point, and virtual camera control information, to the visualization module 130. The visualization module 130 may be configured to superimpose the movement of the virtual object on the background 290 of the virtual environment received from the background generating module 120 and control the virtual camera. The visualization module 130 may configure the user screen while changing the virtual camera according to the location of the virtual object.

For example, the visualization module 130 may track the rise and fall of the virtual object in the background related to the first virtual camera by controlling the first virtual camera near the highest point. The visualization module 130 may adjust the size of the virtual object based on the distance data from the first virtual camera to the virtual object.

For example, the visualization module 130 may start controlling the second virtual camera when the virtual object is out of the field of view of the first virtual camera. The visualization module 130 may superimpose the ground collision motion of the virtual object on the background related to the second virtual camera by controlling the second virtual camera positioned near the drop point. In this case, the virtual camera may be controlled so that the virtual object is positioned at the center of the user screen.

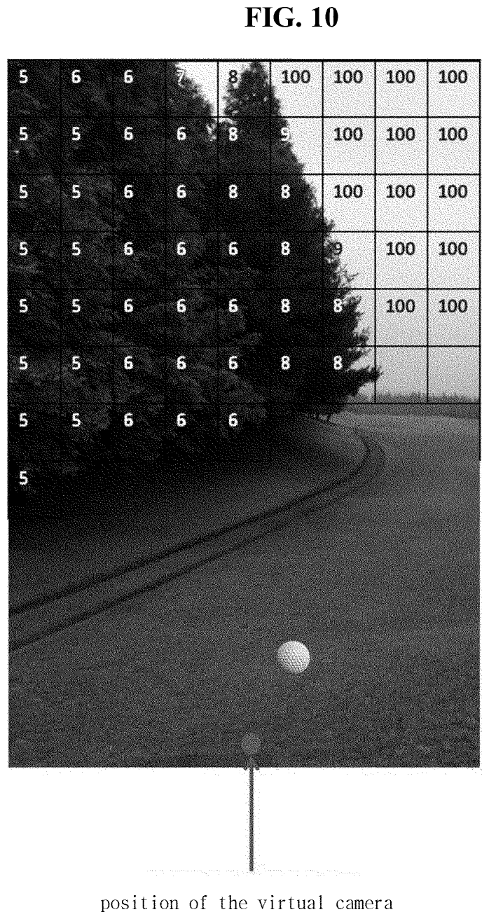

FIG. 10 is a view illustrating the depth data of the simulation system based on the virtual environment 100 according to one embodiment of the disclosure.

In one embodiment, the visualization module 130 may overlap the virtual object, such as the golf ball, by utilizing depth data of structures included in the background 290 of the virtual environment. The background of the virtual environment (e.g., 290 in FIGS. 7A and 7B) may include images or videos generated from the virtual environment data generating module 210. The depth data may be defined as the distance from the virtual camera or the virtual object to structures. The depth data may be stored in the database 220 or storage 160 together with images or videos acquired by the virtual camera.

Referring to FIG. 10, the virtual environment data (e.g., images or videos) may include distance information from the virtual camera to the structures. Using the depth data, the visualization module 130 may overlap the virtual object, such as the golf ball, with the background in a way that overlays the virtual object on the structures, such as trees, or overlays the structures on the virtual object.

The depth data, such as distance information, may be integrated with 3D terrain information that is mapped by the real-time simulation module 110 or may be configured separately, depending on the embodiment.

FIG. 11A is a view illustrating the virtual environment data in a state in which the virtual object is in the tee box. FIG. 11B is a view illustrating the user screen in the tee box.

FIG. 12A is a view illustrating the virtual environment data in a state in which the virtual object is flying. FIG. 12B is a view illustrating the user screen in a state in which the virtual object is flying.

FIG. 13A is a view illustrating the virtual environment data in a state in which the virtual object is falling. FIG. 13B is a view illustrating the user screen in a state in which the virtual object is falling.

Referring to FIGS. 11A and 11B, since the tee box is a point at which simulation starts, the real-time simulation module 110 does not select the virtual camera and the background generating module 120 may select the virtual camera. Specifically, the background generating module 120 may be configured to select a first virtual camera and access the first image or video 410 rendered through the first virtual camera. The background generating module 120 may generate a first background 410 and 412 based on the first image or video 410. In this case, the first background 410 and 412 may be provided by combining the additional image 412 with the first image or video 410. As described above, since the user needs only a relatively narrow field of view in the tee box, the first image or video 410 may be a plane-rendered image. The first user screen 411 shown in FIG. 11B may be a portion of the first backgrounds 410 and 412 shown in FIG. 11A.

In various embodiments, the tee box serves as the starting point of the simulation and remains displayed for a relatively long time, allowing ample time for the video to load. For instance, the first background 410 and 412 may be created based on the first video. Objects (e.g., leaves, clouds, etc.) present in the first backgrounds 410 and 412 of the tee box may exhibit motion derived from the first video. Additionally, the clouds included in the first background 410 and 412 are created by overlaying an additional video onto the still image using the background generating module 120.

Referring to FIG. 11B, the visualization module 130 may display the first user screen 411 by controlling the first virtual camera. The first virtual camera may be controlled so that the virtual player 401 (e.g., the avatar) or the virtual object (e.g., the golf ball) is positioned at the center of the first user screen 411.

Referring to FIG. 11B, when the user performs the tee shot through the input module 150, the real-time simulation module 110 may calculate the predicted highest point and the predicted drop point of the virtual object and select the virtual camera related to the calculated information. The above information may be delivered to the background generating module 120. The background generating module 120 may access rendered images or videos obtained from the second virtual camera and the third virtual camera, to form the second background 420 and 422 and the third background 430 and 432.

Referring to FIG. 11B, when the user performs the tee shot through the input module 150, the real-time simulation module 110 may perform a simulation after mapping the 3D terrain information to the virtual space. The visualization module 130 may display the first trajectory 402 of the virtual object on the first user screen 411 according to the simulation result. In this case, the visualization module 130 may follow the trajectory of the virtual object. For example, the visualization module 130 may display only the trajectory of the virtual object while the first virtual camera is fixed, or rotate the first virtual camera so that the virtual object is positioned at the center of the first user screen 411.

Referring to FIGS. 11B and 12B, the visualization module 130 may switch to the second backgrounds 420 and 422 to form a second user screen 421, if the virtual object is displayed excessively small on the first user screen 411. The second backgrounds 420 and 422 may include the second image or video 420 captured and rendered by the second virtual camera determined immediately after the user input is received. In this case, the second background 420 and 422 may be provided by combining additional images or videos 422 with the second image or video 420. The second user screen 421 may be a portion of the second background 420 and 422. For example, the second background 420 and 422 may be provided in the form of a panorama based on the sphere-rendered image or video 420.

Referring to FIG. 12A, the second virtual camera may be positioned adjacent to the highest point of the virtual object. The visualization module 130 may rotate the second virtual camera so that the virtual object rising to the highest point is positioned at the substantial center of the second user screen 421. For example, as the virtual object rises, the direction of the second virtual camera and the second user screen may also gradually move. The visualization module 130 may rotate the second virtual camera so that the virtual object falling from the highest point is positioned at the substantial center of the second user screen 421. For example, as the virtual object falls, the direction of the second virtual camera and the second user screen 421 may also gradually move.

Referring to FIG. 12A, as described above, the second virtual camera may be a virtual camera defined in a layer (e.g., the second layer 252 or the third layer 253) positioned at a predetermined height above the ground in the virtual space. Also, the second image or video 420, which constitutes the second background 420 and 422, may be rendered in a sphere shape or a half sphere shape. The visualization module 130 may display the trajectory 403 of the virtual object on the second background 420 and 422 and configure the second user screen 421 to include the virtual object.

Referring to FIGS. 12B and 13B, the visualization module 130 may switch to the third background 430 and 432 to form a third user screen 431, if the virtual object appears too small on the second user screen 421. The third background 430 and 432 may include the third image or video 430 captured and rendered by the third virtual camera determined immediately after the user input is received. The third background 430 and 432 may be provided by combining the third image 430 with the additional image or video 432. The third user screen 431 consists of a portion of the third background 430 and 432.

Referring to FIG. 13A, the third virtual camera may be a virtual camera adjacent to the predicted drop point of the virtual object. The visualization module 130 may overlap the virtual object on the third background 430 and 432 by reflecting the result of the ground collision simulation performed by the real-time simulation module 110. The visualization module 130 may display the trajectory 404 of the virtual object on the third background 430 and 432 and configure the third user screen 431 including the virtual object. The visualization module 130 may rotate the third virtual camera so that the virtual object which falls and bounces on the ground is positioned at the substantial center of the third user screen 431 while displaying the trajectory 404 of the virtual object on the third background 430 and 432 and configuring the third user screen 431 including the virtual object, by reflecting the result of the ground collision simulation performed by the real-time simulation module 110.

Referring to FIG. 13A, as described above, the third virtual camera may be a virtual camera defined in a layer (e.g., the first layer 251) located on the ground in the virtual space or a virtual camera defined in a layer (e.g., the second layer 252 and the third layer 253) located at a predetermined height from the ground. Additionally, the third image or video 430 may be rendered in the form of a sphere or a half sphere to constitute the third background.

Referring to FIGS. 12A and 13A, the background generating module 120 may composite the additional video with the second image and the third image to enhance realism.

When the virtual object stops on the ground, the simulation system 100 may be configured to wait until receiving the next user input.

According to embodiments disclosed in the disclosure, the simulation system may provide the user with a high degree of freedom by using the virtual cameras whose field of view, angle of view, number, and location are not limited in the virtual environment.

Moreover, the simulation system may be configured to provide a realistic experience by rendering and preparing a large quantity of high-quality images or videos in advance.

In addition, since the virtual environment is configured by accessing the high-quality images or videos pre-rendered by the user terminal, the user can enjoy high-quality graphic simulation even using a low-end terminal.

Also, the simulation system can be configured as a server-client system. Even in a terminal with limited graphics capabilities, such as a mobile device, by accessing high-quality rendered images or videos stored in a database, the user can experience a high-quality graphic simulation system.

While the disclosure has been shown and described with reference to various embodiments thereof, it will be understood by those skilled in the art that various changes in form and details may be made therein without departing from the spirit and scope of the disclosure as defined by the appended claims and their equivalents.

Hereinafter, those of ordinary skill in the art will recognize that modification, equivalent, and/or alternative on the various embodiments described herein can be variously made without departing from the scope and spirit of the disclosure. With regard to description of drawings, similar components may be marked by similar reference numerals. The terms of a singular form may include plural forms unless otherwise specified. In this disclosure, the expressions “A or B”, “at least one of A and/or B”, “A, B, or C” or “at least one of A, B and/or C”, and the like may include any and all combinations of one or more of the associated listed items. The terms, such as “first”, “second”, and the like may be used to refer to various components regardless of the order and/or the priority and to distinguish the relevant components from other components, but do not limit the components. When an component (e.g., a first component) is referred to as being “(operatively or communicatively) coupled with/to” or “connected to” another component (e.g., a second component), the component may be directly coupled with/to or connected to the other component or an intervening component (e.g., a third component) may be present.

According to the situation, the expression “adapted to” or “configured to” used in this disclosure may be used as, for example, the expression “suitable for”, “having the capacity to”, “adapted to”, “made to”, “capable of”, or “designed to” in hardware or software. The expression “a device configured to” may mean that the device is “capable of” operating together with another device or other parts. For example, a “processor configured to (or set to) perform A, B, and C” may mean a dedicated processor (e.g., an embedded processor) for performing corresponding operations or a generic-purpose processor (e.g., a central processing unit (CPU) or an AP) which performs corresponding operations by executing one or more software programs which are stored in a memory device (e.g., the memory.)

The term “module” used in this disclosure may include a unit composed of hardware, software and firmware and may be interchangeably used with the terms “unit”, “logic”, “logical block”, “part” and “circuit”. The “module” may be an integrated part or may be a minimum unit for performing one or more functions or a part thereof. The “module” may be implemented mechanically or electronically and may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in computer-readable storage media (e.g., the memory in the form of a program module. The instruction, when executed by a processor (e.g., the processor) may cause the processor to perform a function corresponding to the instruction. A computer-readable recording media may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an internal memory. Also, the one or more instructions may contain a code made by a compiler or a code executable by an interpreter.

Each component (e.g., a module or a program module) according to various embodiments may be composed of single entity or a plurality of entities, a part of the above-described sub-components may be omitted, or other sub-components may be further included. Alternatively or additionally, after being integrated in one entity, some components (e.g., a module or a program module) may identically or similarly perform the function executed by each corresponding component before integration. According to various embodiments, operations executed by modules, program modules, or other components may be executed by a successive method, a parallel method, a repeated method, or a heuristic method, or at least one part of operations may be executed in different sequences or omitted. Alternatively, other operations may be added.

What is claimed is:

1. A simulation system comprising:
a storage including a virtual space and virtual environment data based on the virtual space;
a real-time simulation module configured to map terrain data to the virtual space and simulate movement of a virtual object;
a background generating module configured to generate a background of the virtual environment based on the virtual environment data; and
a visualization module configured to superimpose the movement of the virtual object on the background of the virtual environment and display a user screen using a display module.

2. The simulation system of claim 1,
wherein the virtual space includes a plurality of virtual cameras defined in a designated location, and
wherein the virtual environment data includes images or videos obtained through the plurality of virtual cameras before performing the simulation.

3. The simulation system of claim 2,
wherein a plurality of grids and a plurality of intersections are defined in the virtual space, and
wherein each of the plurality of virtual cameras is defined to be located at each of the plurality of intersection points.

4. The simulation system of claim 2,
wherein the virtual space includes a first layer defined on the ground and a second layer defined on the first layer, and
wherein a plurality of grids and a plurality of intersections are defined in each of the first layer and the second layer, and
wherein each of the plurality of virtual cameras is defined to be located at each of the plurality of intersection points.

5. The simulation system of claim 2,
wherein the images or videos include a sphere rendering image or video mapped on an entire sphere, a partial sphere rendering image or video mapped on a portion of an entire sphere, or a plane rendered image or video mapped on a portion of a plane.

6. The simulation system of claim 2,
wherein the virtual environment data includes a data structure in which the location of the virtual camera is an index and images or videos obtained from the virtual camera is data.

7. The simulation system of claim 6,
wherein the data structure includes distance data from the virtual cameras to structures included in the background of the virtual environment.

8. The simulation system of claim 2,
wherein the real-time simulation module is configured to calculate an predicted position of the virtual object through a first simulation and to determine a virtual camera related to the predicted position, and
wherein the background generating module is configured to generate the background of the virtual environment using images or videos obtained from the virtual camera related to the predicted position.

9. The simulation system of claim 8,
wherein the virtual camera related to the predicted position includes a virtual camera defined at the closest distance from the virtual object.

10. The simulation system of claim 8,
wherein the real-time simulation module is configured to perform a second simulation after the first simulation based on the terrain data mapped to the virtual space.

11. The simulation system of claim 1,
wherein the terrain data is displayed transparently in the virtual space.

12. The simulation system of claim 1,
wherein the real-time simulation module is configured to control the direction of the virtual camera so that the virtual object is positioned at the center of the user screen, or to transfer control information of the virtual camera to the visualization module.

13. The simulation system of claim 8,
wherein the predicted position includes a drop point of the virtual object and a highest point of the virtual object.

14. The simulation system of claim 1,
wherein the background generating module is configured to generate a second background based on a second virtual camera defined at a distance closest to a highest point of the virtual object, and
wherein when the virtual object flies, the visualization module is configured to superimpose the virtual object on the second background and track the virtual object by rotating the second virtual camera.

15. The simulation system of claim 2,
wherein the background generating module is configured to generate the background by compositing an additional image or video to the image or video obtained from the virtual camera.

16. The simulation system of claim 15,
wherein the background generating module is configured to render a first area of a first image transparent and to composite a second video onto the first area of the first image.

17. The simulation system of claim 2, further comprising an input module configured to receive a user input related to movement of the virtual object.

18. The simulation system of claim 17,
wherein the input module is configured to receive an input related to a user's field of view shown through the user's screen, and
wherein the visualization module is configured to control the direction of the virtual camera when the input related to the user's field of view is received.
